(19) United States
(12) Patent Application Publication
(10) Pub. No.: US 2011/0243625 A1
(43) Pub. Date: Oct. 6, 2011

(54) IMAGE FORMING APPARATUS, CLEANING APPARATUS, AND CLEANING METHOD

(75) Inventor: Yoshihiko SUGIYAMA, Saitama (JP)

(73) Assignees: Kabushiki Kaisha Toshiba, Tokyo (JP); Toshiba Tec Kabushiki Kaisha, Tokyo (JP)

(21) Appl. No.: 13/042,363

(22) Filed: Mar. 7, 2011

Related U.S. Application Data
(60) Provisional application No. 61/320,280, filed on Apr. 1, 2010.

(51) Int. Cl. G03G 21/00

(52) U.S. Cl. 399/357

(57) ABSTRACT

According to one embodiment, an image forming apparatus includes a foreign-matter removing roller arranged in a post-process of a transfer device. The foreign-mater removing roller includes a rotatable metal shaft and a cylindrical conductive first sponge attached to the outer circumference of the metal shaft. The foreign-matter removing roller is attached a fixed distance apart from the surface of an image carrier and electrostatically attracts foreign matters adhering to the image carrier. A cleaning member scrapes off the foreign matters attracted by the foreign-matter removing roller.

### CROSS-REFERENCE TO RELATED APPLICATION

This application is based upon and claims the priority of U.S. Provisional Application No. 61/320,280, filed on Apr. 1, 2010, the entire contents of which are incorporated herein by reference.

### FIELD

Embodiments described herein relate generally to an image forming apparatus that forms an image on a recording medium such as a sheet and a cleaning apparatus and a cleaning method for removing foreign matters such as paper powder and a residual toner that adhere to an image carrier when an image is formed.

### BACKGROUND

In general, an image forming apparatus of an electrophotographic recording system radiates a laser beam on a photoconductive drum to form an electrostatic latent image. A developing device forms a toner image on the photoconductive drum. The toner image is transferred onto a sheet to obtain an image.

In the image forming apparatus in the past, in some cases, foreign matters such as paper powder and a residual toner adhere to the surface of the photoconductive drum after the transfer. If the foreign matters adhere, the quality of the image is deteriorated. Therefore, the foreign matters are removed by a cleaning apparatus.

As an example, the cleaning apparatus cleans the surface of the photoconductive drum using a blade. However, in some cases, the surface of the photoconductive drum is scratched. Recently, there is also a cleaner-less structure. However, the cleaner-less structure is insufficient for surely removing the foreign matters.

### BRIEF DESCRIPTION OF THE DRAWINGS

FIG. 1 is a diagram of an image forming apparatus according to an embodiment;

FIG. 2 is an enlarged diagram of an image forming unit in the embodiment;

FIG. 3 is an enlarged diagram of a cleaning apparatus in the embodiment;

FIG. 4 is a diagram of a modification of the cleaning apparatus in the embodiment; and

FIG. 5 is a diagram of another modification of the cleaning apparatus in the embodiment.

### DETAILED DESCRIPTION

In general, according to an embodiment, an image forming apparatus includes: an image carrier on which a laser beam is radiated and an electrostatic latent image is formed; a developing device configured to supply a developer to the image carrier; a transfer device configured to transfer a toner image formed on the image carrier by the developing device onto a recording medium; a foreign-matter removing roller arranged in a post-process of the transfer device and including a rotatable metal shaft and a cylindrical conductive first sponge attached to the outer circumference of the metal shaft, the foreign-matter removing roller being attached a fixed distance apart from the surface of the image carrier and configured to electrostatically attract foreign matters adhering to the image carrier; a cleaning member configured to scrape off the foreign matters attracted by the foreign-matter removing roller; and a storing unit configured to store the scraped-off foreign matters.

An image forming apparatus according to an embodiment is explained below with reference to the accompanying drawings. In the drawings, the same components are denoted by the same reference numerals and signs.

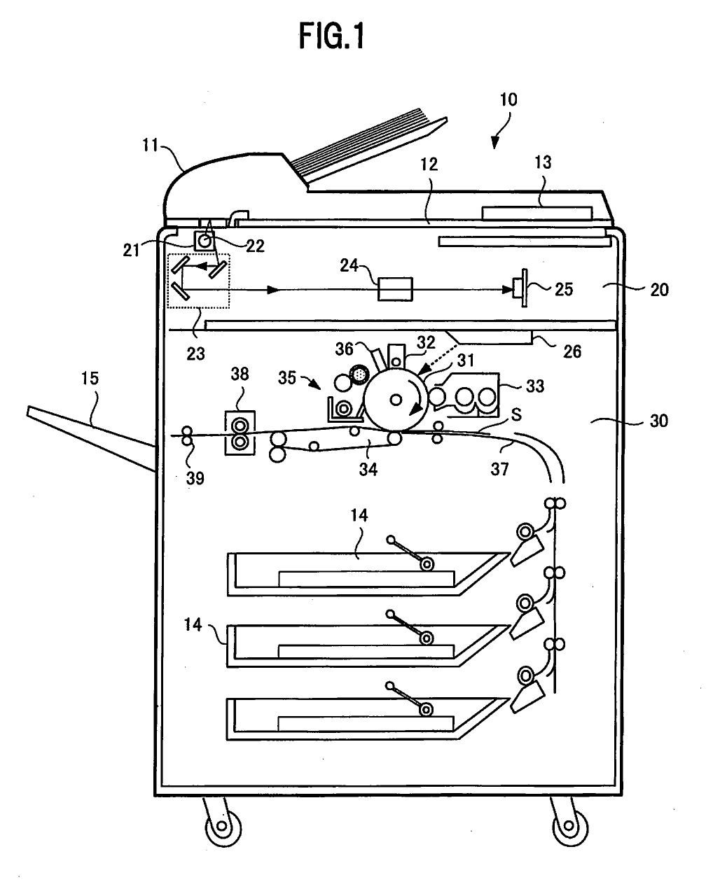

FIG. 1 is a diagram of the image forming apparatus according to the embodiment. In FIG. 1, an image forming apparatus 10 is, for example, an MFP (Multi-Function Peripherals), which is a complex machine, a printer, or a copying machine. In the following explanation, the MFP is explained as an example of the image forming apparatus.

The image forming apparatus (the MFP) 10 includes, in an upper part thereof, an auto document feeder (ADF) 11, a transparent document table 12, and an operation panel 13. Plural paper feeding devices 14 are provided in a lower part of the MFP 10. A tray 15 on which sheets are stacked is provided on a side of the MFP 10.

The MFP 10 includes a scanner unit 20 and a printer unit 30. The scanner unit 20 reads an image of an original document. The printer unit 30 forms an image on a recording medium such as a sheet on the basis of read data. In an example explained below, a sheet S is used as the recording medium.

The scanner unit 20 includes a carriage 21, an exposure lamp 22, a reflection mirror 23, a lens 24, a CCD (Charge Coupled Device) 25, and a laser unit 26. In order to scan and read an original document fed by the ADF 11 or an original document placed on the document table 12, the scanner unit 20 radiates light, which is received from the exposure lamp 22 provided in the carriage 21, on the original document from below the document table 12. The scanner unit 20 captures reflected light from the original document into the CCD 25 via the reflection mirror 23 and the lens 24.

Image information captured into the CCD 25 is output as an analog signal. The analog signal is converted into a digital signal. The digital signal is subjected to image processing and image data is generated. The image data is supplied to the laser unit 26. The laser unit 26 generates a laser beam according to the image data.

The printer unit 30 includes a rotatable photoconductive drum 31. The photoconductive drum 31 is an image carrier. The printer unit 30 includes a charging device 32, a developing device 33, a transfer device 34, a cleaning apparatus 35, and a charge removing lamp 36 around the photoconductive drum 31 along a rotating direction of the photoconductive drum 31. The laser unit 26 radiates the laser beam on the photoconductive drum 31. An electrostatic latent image corresponding to the image information of the original document is formed on the outer circumferential surface of the photoconductive drum 31.

When image formation is started, the charging device 32 discharges in a predetermined discharge position and uniformly charges the outer circumferential surface of the rotating photoconductive drum 31 in an axis direction of the photoconductive drum 31. The laser unit 26 radiates the laser beam on the photoconductive drum 31. An electrostatic latent image is formed and held on the outer circumferential surface of the photoconductive drum 31.

The developing device 33 supplies a developer (e.g., a toner) to the outer circumferential surface of the photoconductive drum 31. The electrostatic latent image is converted and developed into a toner image. The transfer device 34 electrostatically transfers the toner image formed on the outer circumferential surface of the photoconductive drum 31 onto the sheet S. The sheet S is conveyed from the paper feeding devices 14 through a conveying path 37.

The cleaning apparatus 35 arranged in a post-process of the transfer device 34 removes foreign matters such as paper powder remaining on the photoconductive drum 31. The post-process of the transfer device 34 means a process between the transfer device 34 and the charging device 32 along the rotating direction of the photoconductive drum 31. The charge removing lamp 36 removes residual charges on the outer circumferential surface of the photoconductive drum 31.

The configuration of the printer unit 30 is not limited to the example shown in the figure. Other systems, for example, a system employing an intermediate transfer belt can also be used. In FIG. 1, an image forming unit is shown in a simplified form. However, when a color image is formed, the MFP 10 includes color image forming units for black, magenta, cyan, yellow, and the like. The MFP 10 can also process print data input from a PC (Personal Computer) or the like, output the print data to the printer unit 30, and print the print data.

The sheet S having the toner image transferred thereon by the printer unit 30 is conveyed to a fixing device 38. In the fixing device 38, a fixing roller and a pressing roller are arranged to be opposed to each other. The sheet S is conveyed between the fixing roller and the pressing roller to fix the toner image, which is transferred onto the sheet S, on the sheet S. A paper discharge roller 39 discharges the sheet S, on which the toner image is fixed and image formation is completed, to the tray 15.

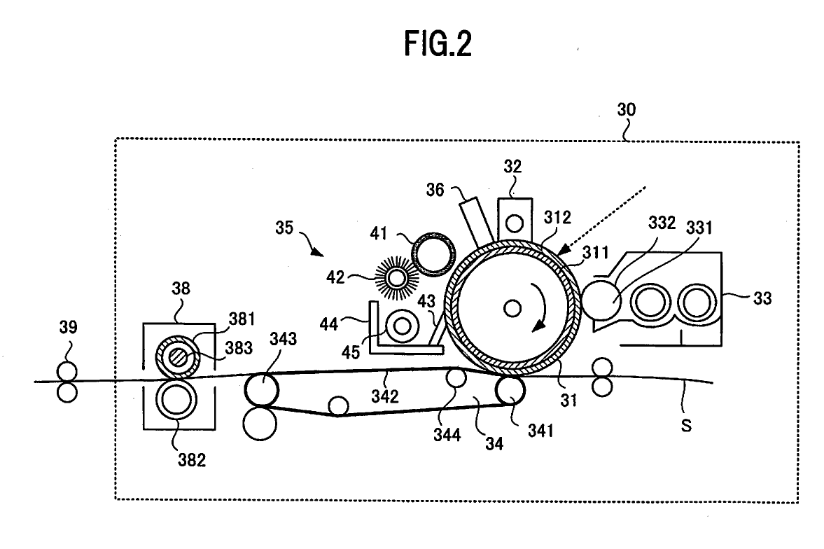

FIG. 2 is an enlarged diagram of the image forming unit 30. In FIG. 2, the photoconductive drum 31 includes, for example, a metal substrate 311 made of hollow aluminum and a photoconductive layer 312 formed on the surface of the metal substrate 311. The photoconductive layer 312 includes, for example, an organic photoconductive member (OPC). The metal substrate 311 is electrically grounded to a housing unit of the image forming apparatus 10.

The developing device 33 includes a magnet roller 331 and a developing sleeve 332 configured to rotate on the outer circumference of the magnet roller 331. The magnet roller 331 selectively supplies a toner, which moves on the surface of the developing sleeve 332, to a latent image on the surface of the photoconductive drum 31 while magnetically attracting the toner.

The transfer device 34 includes a transfer roller 341, a sheet conveying belt 342, a driven roller 343, and a peeling device 344. The sheet conveying belt 342 is rotated by the transfer roller 341 and the driven roller 343 and conveys the sheet S. The transfer device 34 transfers, with an electric field provided by the transfer roller 341, a toner image onto the sheet S conveyed on the sheet conveying belt 342. The peeling device 344 separates the sheet S, to which the toner adheres, from the surface of the photoconductive drum 31.

The cleaning apparatus 35 includes a foreign-matter removing roller 41, a cleaning member 42, a seal material 43, a foreign-matter storing unit 44, and a foreign-matter conveying roller 45. The foreign-matter removing roller 41 electrostatically attracts foreign matters such as paper powder and a residual toner adhering to the surface of the photoconductive drum 31. The cleaning member 42 includes, for example, a cylindrical brush and drops the foreign matters attracted by the foreign-matter removing roller 41 to the foreign-matter storing unit 44. The foreign-matter conveying roller 45 conveys the foreign matters dropped to the foreign-matter storing unit 44 to a collection box. The configuration of a main part of the cleaning apparatus 35 is explained later.

The fixing device 38 includes a fixing roller 381 and a pressing roller 382. The fixing roller 381 includes a heater 383 for heating on the inside thereof. The fixing roller 381 and the pressing roller 382 rotate while being in contact with each other. The sheet S passes between the fixing roller 381 and the pressing roller 382, whereby fixing roller 381 fixes the toner, which adheres to the sheet S, on the sheet S.

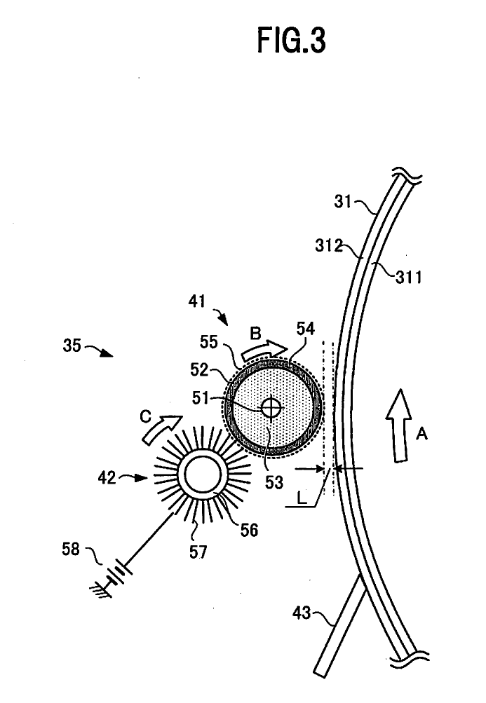

FIG. 3 is an enlarged diagram of the configuration of the main part of the cleaning apparatus 35.

The foreign-matter removing roller 41 of the cleaning apparatus 35 is provided near and spaced a fixed distance L apart from the surface of the photoconductive later 312 of the photoconductive drum 31 and is in noncontact with the photoconductive layer 312.

In the foreign-matter removing roller 41, a sponge roller 52 is attached to the outer circumference of a metal shaft 51. The sponge roller 52 is formed by covering the outer circumference of a sponge 53 with a cylindrical tube 54. The sponge 53 and the tube 54 are formed by, for example, adding ECO (epichlorohydrin rubber) to NBR (nitrile-butadiene rubber). A high-resistance coating material 55 may be applied to the outer circumference of the tube 54. The high-resistance coating material 55 is obtained by, for example, dispersing and applying fluorine to urethane rubber.

In the cleaning member 42, a conductive brush 57 is radially attached to the outer circumference of a metal shaft 56. The brush 57 is in contact with the foreign-matter removing roller 41. For example, rayon fiber is used for the brush 57.

The cleaning apparatus 35 includes a bias source 58 and applies a bias voltage to the metal shafts 51 and 56. At least the sponge roller 52 of the sponge roller 52 and the brush 57 is made conductive by the application of the bias voltage. Therefore, foreign matters such as paper powder and a residual toner adhering to the surface of the photoconductive layer 312 can be electrostatically attracted to the foreign-matter removing roller 41.

Since the foreign-matter removing roller 41 is opposed to the photoconductive layer 312 at a distance L, possible to prevent the photoconductive layer 312 from being scratched. Since the sponge 53 is covered with the tube 54, possible to prevent clogging of the sponge 53.

For example, if the photoconductive drum 31 rotates clockwise as indicated by an arrow A, the foreign-matter removing roller 41 rotates in a counter direction (an arrow B direction) with respect to the rotating direction of the photoconductive drum 31. Therefore, be possible to improve an effect of removing the foreign matters adhering to the photoconductive layer 312.

The cleaning member 42 rotates in a counter direction (an arrow C direction) with respect to the rotating direction of the foreign-matter removing roller 41. Therefore, be possible to easily scrape off, with the brush 57, the foreign matters attracted by the foreign-matter removing roller 41.

The seal material 43 prevents a residual toner from leaking to the outside of the foreign-matter storing unit 44 along the outer circumference of the photoconductive drum 31.

As explained above, the foreign-matter removing roller 41 of the cleaning apparatus 35 can remove the foreign matters while being in noncontact with the photoconductive drum 31. The cleaning member 42 can scrape off, with the brush 57, the foreign matters attracted by the foreign-matter removing roller 41 and store the foreign matters in the foreign-matter storing unit 44 (FIG. 2).

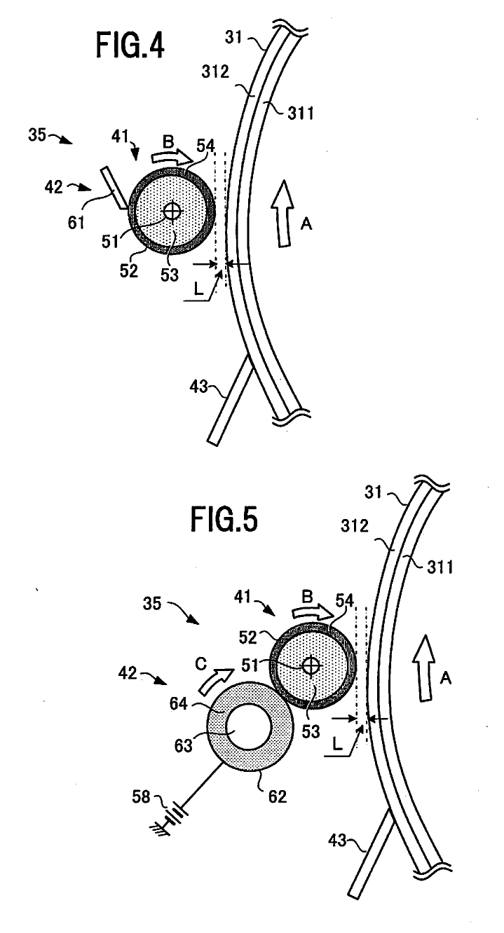

FIG. 4 is a diagram of a modification of the cleaning apparatus 35.

In the example shown in FIG. 4, a urethane sheet 61 is set in contact with the surface of the foreign-matter removing roller 41 instead of the cleaning member 42 shown in FIG. 3. The urethane sheet 61 is arranged at an angle counter to the rotating direction (the arrow B direction) of the foreign-matter removing roller 41. The urethane sheet 61 plays a role of scraping off the foreign matters attracted by the foreign-matter removing roller 41.

FIG. 5 is a diagram of another modification of the cleaning apparatus 35.

In the example shown in FIG. 5, a sponge roller 62 is provided instead of the cleaning member 42 shown in FIG. 3. The sponge roller 62 is set in contact with the surface of the foreign-matter removing roller 41. In the sponge roller 62, a cylindrical sponge 64 is attached to the outer circumference of a metal shaft 63. The metal shaft 63 is rotated in the counter direction (the arrow C direction) with respect to the rotating direction (the arrow B direction) of the foreign-matter removing roller 41.

The cleaning apparatus 35 shown in FIG. 5 includes a bias source 58 and applies a bias voltage to the metal shafts 51 and 63. At least the sponge roller 52 of the sponge roller 52 and the sponge roller 62 is made conductive by the application of the bias voltage. Therefore, the foreign matters such as paper powder and a residual toner adhering to the surface of the photoconductive layer 312 can be electrostatically attracted to the foreign-matter removing roller 41. The sponge roller 62 plays a role of electrostatically attracting the foreign matters attracted by the foreign-matter removing roller 41.

According to the embodiments explained above, possible to accurately remove, in a noncontact manner, foreign matters adhering to the surface of the photoconductive drum. Since the foreign-matter removing roller is in noncontact with the photoconductive drum, the photoconductive drum is not scratched.

Various modifications are possible without being limited to the embodiments. For example, the materials of the sections of the foreign-matter removing roller 41 are not limited to the examples explained above. Other materials can also be used.

While certain embodiments have been described, these embodiments have been presented by way of example only, and are not intended to limit the scope of the invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image carrier on which a laser beam is radiated and an electrostatic latent image is formed;
a developing device configured to supply a developer to the image carrier;
a transfer device configured to transfer a toner image formed on the image carrier by the developing device onto a recording medium;
a foreign-matter removing roller arranged in a post-process of the transfer device and including a rotatable metal shaft and a cylindrical conductive first sponge attached to an outer circumference of the metal shaft, the foreign-matter removing roller being attached a fixed distance apart from a surface of the image carrier and configured to electrostatically attract foreign matters adhering to the image carrier;
a cleaning member configured to scrape off the foreign matters attracted by the foreign-matter removing roller; and
a storing unit configured to store the scraped-off foreign matters.

2. The apparatus of claim 1, wherein the foreign-matter removing roller rotates in a counter direction with respect to a rotating direction of the image carrier.

3. The apparatus of claim 1, wherein the cleaning member includes a brush radially attached to the outer circumference of the rotatable metal shaft, the brush rotating in a counter direction with respect to a rotating direction of the foreign-matter removing roller while being in contact with the foreign-matter removing roller.

4. The apparatus of claim 1, wherein the cleaning member includes a urethane sheet that is in contact with an outer circumference of the foreign-matter removing roller and scrapes off the foreign matters adhering to the foreign-matter removing roller.

5. The apparatus of claim 1, wherein the cleaning member includes a rotatable metal shaft and a cylindrical second sponge attached to an outer circumference of the metal shaft, the second sponge rotating in a counter direction with respect to a rotating direction of the foreign-matter removing roller while being in contact with the foreign matter removing roller.

6. The apparatus of claim 1, further comprising a bias source configured to apply a bias voltage to at least the foreign-matter removing roller of the foreign-matter removing roller and the cleaning member.

7. A cleaning apparatus comprising:
a foreign-matter removing roller arranged in a process after transfer of a toner image, which is formed on an image carrier, onto a recording medium and including a rotatable metal shaft and a cylindrical conductive first sponge attached to an outer circumference of the metal shaft, the foreign-matter removing roller being attached a fixed distance apart from a surface of the image carrier and configured to electrostatically attract foreign matters adhering to the image carrier;
a cleaning member configured to scrape off the foreign matters attracted by the foreign-matter removing roller; and
a storing unit configured to store the scraped-off foreign matters.

8. The apparatus of claim 7, wherein the foreign-matter removing roller rotates in a counter direction with respect to a rotating direction of the image carrier.

9. The apparatus of claim 8, wherein the foreign-matter removing roller is formed by covering an outer circumference of the first sponge with a rubber tube.

10. The apparatus of claim 9, wherein the foreign-matter removing roller is formed by further applying a high-resistance coating material to an outer circumference of the tube.

11. The apparatus of claim 7, wherein the cleaning member includes a brush radially attached to the outer circumference of the rotatable metal shaft, the brush rotating in a counter direction with respect to a rotating direction of the foreign-matter removing roller while being in contact with the foreign-matter removing roller.

12. The apparatus of claim 7, wherein the cleaning member includes a urethane sheet that is in contact with an outer circumference of the foreign-matter removing roller and scrapes off the foreign matters adhering to the foreign-matter removing roller.

13. The apparatus of claim 7, wherein the cleaning member includes a rotatable metal shaft and a cylindrical second sponge attached to an outer circumference of the metal shaft, the second sponge rotating in a counter direction with respect to a rotating direction of the foreign-matter removing roller while being in contact with the foreign matter removing roller.

14. The apparatus of claim 7, further comprising a bias source configured to apply a bias voltage to at least the foreign-matter removing roller of the foreign-matter removing roller and the cleaning member.

15. A cleaning method comprising:
arranging a foreign-matter removing roller including, in a process after transfer of a toner image, which is formed on an image carrier, onto a recording medium, a rotatable metal shaft and a cylindrical conductive first sponge attached to an outer circumference of the metal shaft,
attaching the foreign-matter removing roller a fixed distance apart from a surface of the image carrier;
electrostatically attracting, with the foreign-matter removing roller, foreign matters adhering to the image carrier;
scraping off, with a cleaning member, the foreign matters attracted by the foreign-matter removing roller; and
storing the scraped-off foreign matters in a storing unit.

16. The method of claim 15, wherein the foreign-matter removing roller rotates in a counter direction with respect to a rotating direction of the image carrier.

17. The method of claim 15, wherein the cleaning member includes a brush radially attached to the outer circumference of the rotatable metal shaft, the cleaning member rotating the brush in a counter direction with respect to a rotating direction of the foreign-matter removing roller while setting the brush in contact with the foreign-matter removing roller.

18. The method of claim 15, wherein the cleaning member includes a urethane sheet that is in contact with an outer circumference of the foreign-matter removing roller, the cleaning member scraping off, with the urethane sheet, the foreign matters adhering to the foreign-matter removing roller.

19. The method of claim 15, wherein the cleaning member includes a cylindrical second sponge attached to an outer circumference of a rotatable metal shaft, the cleaning member rotating the second sponge in a counter direction with respect to a rotating direction of the foreign-matter removing roller while setting the second sponge in contact with the foreign matter removing roller.

20. The method of claim 15, further comprising applying a bias voltage to at least the foreign-matter removing roller of the foreign-matter removing roller and the cleaning member.
